(19) United States
(12) Patent Application Publication
(10) Pub. No.: US 2008/0125571 A1
(43) Pub. Date: May 29, 2008

(54) Production Process Of Electrically Conducting Polymer

(75) Inventors: Hideki Oohata, Nagano (JP); Yong Lei, Kanagawa (JP); Takakazu Yamamoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignees: Showa Denko K.K.,, Tokyo (JP); Tokyo Institute of Technology, Tokyo (JP)

(21) Appl. No.: 11/665,162

(22) PCT Filed: Oct. 12, 2005
(86) PCT No.: PCT/JP05/19154

§ 371 Date: May 8, 2007

Related U.S. Application Data
(60) Provisional application No. 60/619,717, filed on Oct. 19, 2004.

(30) Foreign Application Priority Data
Oct. 13, 2004 (JP) 2004-298873

(51) Int. Cl. C08G 75/32

(52) U.S. Cl. 528/378; 528/423

(57) ABSTRACT

The present invention provides a process for producing a conductive polymer, characterized by comprising conducting polymerization in the presence of a polymerizable monomer, a surfactant, a solvent and an oxidizing agent under initial conditions that a concentration of the polymerizable monomer is from 0.20 to 2.8 mol/L and a molar ratio of the surfactant is from 0.8 to 1.6 mol per mol of the polymerizable monomer; and a conductive polymer obtained by the method. Since the conductive polymer of the present invention has high conductivity, it is useful as constituent members of electrochemical elements.

### CROSS REFERENCE TO THE RELATED APPLICATIONS

This is an application filed pursuant to 35 U.S.C. Section 111(a) with claiming the benefit of U.S. Provisional application Ser. No. 60/619,717 filed Oct. 19, 2004 under the provision of 35 U.S.C. Section 111(b), pursuant to 35 U.S.C. Section 119(e)(1).

### TECHNICAL FIELD

The present invention relates to a process for producing a novel π-conjugated polymer having high conductivity, and a conductive polymer obtained by the process. More specifically, it relates to a process for producing a novel π-conjugated polymer which is appropriately used as various conductive materials having high workability demand in the field of the electronics, such as an electrode, a sensor, an electronics display device, a photoelectric transducer and an antistatic material, optical materials or constituent members of various electronic parts; and a conductive polymer obtained by the process.

### BACKGROUND ART

Heretofore, with respect to π-conjugated polymers typified by polyaniline, polypyrrole and polythiophene, specific electronic, magnetic and optical characteristics shown by π electrons thereof have attracted much interest, and various studies and developments have been conducted.

Of these, π-conjugated polymer materials having high conductivity are being utilized as materials to replace metallic materials and metal oxide materials defective in processability, antistatic materials and constituent members of organic EL display devices, and further as solid electrolytes of solid electrolytic capacitors.

Especially in recent years, the demand for personal computers has been increased to further improve functionality. In this connection, electronic parts to meet specifications for operations in higher frequency have been required. Thus, products having high performance have been in demand.

A typical method for producing π-conjugated polymers includes an electrolytic polymerization method and a chemical oxidative polymerization method. In the former electrolytic polymerization method, a polymerizable monomer is dissolved in an electrochemical cell containing an electrolyte having dissolved therein a support electrolyte, and a dense film-like polymer is formed on, for example, a platinum electrode by controlling current density and voltage. Generally, the polymer is obtained as a polymer having high conductivity. However, in the electrolytic polymerization method, the size of the resulting polymer depends on the electrode area of the device. Accordingly, it is hard to obtain a thin film with a large area. It is further inappropriate for production of a film having an intricate shape. This method therefore has industrial and economical problems.

On the other hand, the latter chemical oxidative polymerization method is an industrially useful technique because the π-conjugated polymer is easily obtained by mixing the polymerizable monomer with an appropriate oxidizing agent. However, there are defects that the resulting polymer is generally in the form of fine particles and its conductivity is low compared with that of the polymer obtained by the electrolytic polymerization.

A large number of π-conjugated materials having high conductivity and methods for producing the same have been so far proposed. For example, a method in which orientation is increased by a mechanical method such as drawing of a material to increase conductivity has been proposed. Although this method is useful for a highly dense film-like polymer, it makes technically impossible the drawing orientation in a micro-region of a porous electrode.

A large number of methods in which polymerization regularity of a π-conjugated polymer is increased by an electromagnetic method using an electric field or a magnetic field to improve conductivity. However, the methods require an equipment for exclusive use, and there are industrial problems in productivity and cost.

In order to solve these problems, various approaches have been made in view of the development of materials. For example, JP-T-7-509743 (the term “JP-T” as used herein means a published Japanese translation of a PCT patent application) discloses a method for forming conductive polyaniline, which comprises (i) a step of forming an emulsion comprising (1) a polar solution, (2) a non-polar or weakly polar solution immiscible with the polar solution, (3) at least one aniline and (4) at least one functional protonic acid, and (ii) a step of adding an oxidizing agent to the emulsion for inducing polymerization of the aniline.

Conductivity of the polyaniline obtained by the foregoing method is, however, only several S/cm. Even in Examples in which high conductivity is obtained, the value is a measured value of a film obtained by a casting method or the like, which is generally expected to be much higher than a value measured by a four terminal method using a granular polymer in the form of compressed pellets. Accordingly, the conductivity of the polyaniline obtained by this polymerization method is not said to be substantially high.

JP-A-2001-278964 discloses a method for producing a conductive polymer which comprises polymerizing a polymerizable monomer in a medium containing an anionic surfactant, a persulfate and a transition metal salt having a lower molar concentration than the persulfate.

In this method, however, the transition metal salt is used at a low molar concentration for preventing inhibition of polymerization accompanied by the use of the persulfate. Accordingly, a concentration of a reaction solution is low, and conductivity of the resulting conductive polymer is also low.

Synthetic Metals, 95 (1998) 191-196 by Kudo et al. discloses that pyrrole is subjected to chemical oxidative polymerization in an aqueous medium containing an iron salt, a sulfuric acid-based surfactant and phenolic derivatives and conductivity of the resulting polypyrrole is approximately 40 S/cm at the highest.

Synthetic Metals, 98 (1998) 65-70 by Kudo et al. discloses that 3,4-ethylenedioxythiophene is subjected to chemical oxidative polymerization in an aqueous medium containing an anionic surfactant to obtain poly(3,4-ethylenedioxythiophene) having high conductivity and its conductivity is approximately 60 S/cm.

### DISCLOSURE OF THE INVENTION

An object of the invention is to provide a conductive polymer having high conductivity, a process for producing the same, and a conductive polymer obtained by the process and useful as a constituent member of electrochemical elements and the like.

As a result of intensive studies, the present inventors have found that the problems can be solved by conducting polymerization such that initial concentrations of a polymerizable monomer and a surfactant are adjusted to be more than specific concentrations. On the basis of such a finding, the invention has been completed. That is, the invention includes, for example, the following matters.

1. A process for producing a conductive polymer, characterized by comprising conducting polymerization in the presence of a polymerizable monomer, a surfactant, a solvent and an oxidizing agent under initial conditions that a concentration of the polymerizable monomer is from 0.20 to 2.8 mol/L and a molar ratio of the surfactant is from 0.8 to 1.6 mol per mol of the polymerizable monomer.

2. The process for producing the conductive polymer according to 1 above, wherein the polymerizable monomer is represented by the general formula (I):

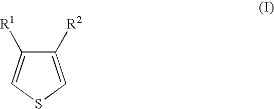

wherein R¹ and R², independently from each other, represent a monovalent group selected from the group consisting of a hydrogen atom, a linear or branched, saturated or unsaturated alkyl group having from 1 to 10 carbon atoms, a linear or branched, saturated or unsaturated alkoxy group having from 1 to 10 carbon atoms, a linear or branched, saturated or unsaturated alkyl ester group having from 1 to 10 carbon atoms, a halogen atom, a nitro group, a cyano group, a primary, secondary or tertiary amino group, a trihalomethyl group, a phenyl group and a phenyl group having a substituent.

3. The process for producing the conductive polymer according to 1 above, wherein the polymerizable monomer is represented by the general formula (II):

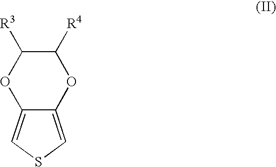

wherein R³ and R⁴, independently from each other, represent a monovalent group selected from the group consisting of a hydrogen atom, a linear or branched, saturated or unsaturated alkyl group having from 1 to 10 carbon atoms, a linear or branched, saturated or unsaturated alkoxy group having from 1 to 10 carbon atoms, a linear or branched, saturated or unsaturated alkyl ester group having from 1 to 10 carbon atoms, a halogen atom, a nitro group, a cyano group, a primary, secondary or tertiary amino group, a trihalomethyl group, a phenyl group and a phenyl group having a substituent.

4. The process for producing the conductive polymer according to 3 above, wherein the polymerizable monomer is 2,3-dihydrothieno[3,4-b][1,4]dioxine.

5. The process for producing the conductive polymer according to 1 above, wherein the polymerizable monomer is represented by the general formula (III):

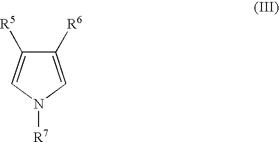

wherein R⁵, R⁶ and R⁷, independently from each other, represent a monovalent group selected from the group consisting of a hydrogen atom, a linear or branched, saturated or unsaturated alkyl group having from 1 to 10 carbon atoms, a linear or branched, saturated or unsaturated alkoxy group having from 1 to 10 carbon atoms, a linear or branched, saturated or unsaturated alkyl ester group having from 1 to 10 carbon atoms, a halogen atom, a nitro group, a cyano group, a primary, secondary or tertiary amino group, a trihalomethyl group, a phenyl group and a phenyl group having a substituent.

6. The process for producing the conductive polymer according to 5 above, wherein the polymerizable monomer is pyrrole.

7. The process for producing the conductive polymer according to 1 above, wherein the surfactant is an organic sulfonic acid compound.

8. The process for producing the conductive polymer according to 7 above, wherein the organic sulfonic acid compound is sodium naphthalenesulfonate or a derivative thereof.

9. The process for producing the conductive polymer according to 1 above, wherein the oxidizing agent is an iron salt.

10. The process for producing the conductive polymer according to 1 above, wherein the molar ratio of the surfactant is from 0.9 to 1.5 mol per mol of the polymerizable monomer.

11. The process for producing the conductive polymer according to 1 above, wherein the molar ratio of the oxidizing agent is from 0.05 to 1.5 mol per mol of the polymerizable monomer.

12. A conductive polymer obtained by the process according to any of 1 to 11 above.

### BEST MODE FOR CARRYING OUT THE INVENTION

The invention is described in more detail below.

The invention relates to a process for producing a conductive polymer, characterized by comprising conducting polymerization in the presence of a polymerizable monomer, a surfactant, a solvent and an oxidizing agent under initial conditions that a concentration of the polymerizable monomer is from 0.2 to 2.8 mol/L and a molar ratio of the surfactant is from 0.8 to 1.6 mol per mol of the polymerizable monomer.

The polymerizable monomer used in the invention includes thiophenes represented by the following general formula (I):

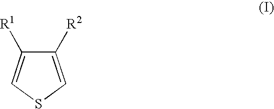

wherein R¹ and R², independently from each other, represent a monovalent group selected from the group consisting of a hydrogen atom, a linear or branched, saturated or unsaturated alkyl group having from 1 to 10 carbon atoms, a linear or branched, saturated or unsaturated alkoxy group having from 1 to 10 carbon atoms, a linear or branched, saturated or unsaturated alkyl ester group having from 1 to 10 carbon atoms, a halogen atom, a nitro group, a cyano group, a primary, secondary or tertiary amino group, a trihalomethyl group, a phenyl group and a substituted phenyl group.

R¹ and R² may be bonded to each other in any position to form at least one 3- to 7-membered, saturated or unsaturated hydrocarbon cyclic structure. The cyclic structure may arbitrarily contain a carbonyl, ether, ester, amide, sulfide, sulfinyl, sulfonyl or imino bond, and the hydrocarbon forming the cyclic structure may have a group selected from the group consisting of a linear or branched, saturated or unsaturated alkyl group having from 1 to 10 carbon atoms, a linear or branched, saturated or unsaturated alkoxy group having from 1 to 10 carbon atoms, a linear or branched, saturated or unsaturated alkyl ester group having from 1 to 10 carbon atoms, a halogen atom, a nitro group, a cyano group, a primary, secondary or tertiary amino group, a trihalomethyl group, a phenyl group and a phenyl group having a substituent.

Specific examples of the linear or branched, saturated or unsaturated alkyl group having from 1 to 10 carbon atoms include a methyl group, an ethyl group, a propyl group, an isopropyl group, a butyl group, a t-butyl group, a pentyl group, a hexyl group, an octyl group, a vinyl group, an allyl group, a 1-butenyl group, a 3-butenyl group, a 5-hexenyl group and the like.

Specific examples of the linear or branched, saturated or unsaturated alkoxy group having from 1 to 10 carbon atoms include a methoxy group, an ethoxy group, a propoxy group, an isopropoxy group, a butoxy group, a pentoxy group, a hexyloxy group, an octyloxy group and the like.

Specific examples of the linear or branched, saturated or unsaturated alkyl ester group having from 1 to 10 carbon atoms include a methyl ester group, an ethyl ester group, a propyl ester group, an isopropyl ester group, a butyl ester group, a pentyl ester group, a hexyl ester group, an octyl ester group and the like.

Specific examples of the halogen atom include chlorine, bromine, fluorine and the like. Specific examples of the primary, secondary or tertiary amino group include a methylamino group, an ethylamino group, a propylamino group, a butylamino group, a pentylamino group, a hexylamino group, a dimethylamino group and the like. Specific examples of the trihalomethyl group include a trichloromethyl group, a tribromomethyl group, a trifluoromethyl group and the like. Specific examples of the phenyl group and the phenyl group having a substituent include a phenyl group substituted with a halogen group such as chlorine, bromine or fluorine, a tolyl group, a biphenyl group and the like.

Specific examples of the monomer represented by the formula (I) include thiophene and derivatives thereof such as 3-methylthiophene, 3-ethylthiophene, 3-propylthiophene, 3-butylthiophene, 3-pentylthiophene, 3-hexylthiophene, 3-heptylthiophene, 3-octylthiophene, 3-nonylthiophene, 3-decylthiophene, 3-fluorothiophene, 3-chlorothiophehe, 3-bromothiophene, 3-cyanothiophene, 3,4-dimethylthiophene, 3,4-diethylthiophene, 3,4-butylenethiophene and 3,4-methylenedioxythiophene.

Examples of another polymerizable monomer used in the invention include 3,4-ethylenedioxythiophene represented by the following general formula (II):

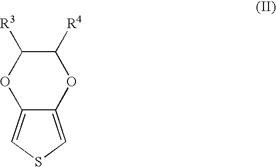

wherein R³ and R⁴, independently from each other, represent a monovalent group selected from the group consisting of a hydrogen atom, a linear or branched, saturated or unsaturated alkyl group having from 1 to 10 carbon atoms, a linear or branched, saturated or unsaturated alkoxy group having from 1 to 10 carbon atoms, a linear or branched, saturated or unsaturated alkyl ester group having from 1 to 10 carbon atoms, a halogen atom, a nitro group, a cyano group, a primary, secondary or tertiary amino group, a trihalomethyl group, a phenyl group and a substituted phenyl group; and derivatives thereof.

R³ and R⁴ may be bonded to each other in any position to form at least one 3- to 7-membered, saturated or unsaturated hydrocarbon cyclic structure. The cyclic structure may arbitrarily contain a carbonyl, ether, ester, amide, sulfide, sulfinyl, sulfonyl or imino bond, and the hydrocarbon forming the cyclic structure may have a group selected from the group consisting of a linear or branched, saturated or unsaturated alkyl, alkoxy or alkyl ester group having from 1 to 10 carbon atoms, a halogen atom, a nitro group, a cyano group, a primary, secondary or tertiary amino group, a trihalomethyl group, a phenyl group and a phenyl group having a substituent.

Specific examples of the monomer represented by the formula (II) include 2,3-dihydrothieno[3,4-b][1,4]dioxine, 2-methyl-2,3-dihydrothieno[3,4-b][1,4]dioxine, 2-ethyl-2,3-dihydrothieno[3,4-b][1,4]dioxine, 2-(1-propyl)-2,3-dihydrothieno[3,4-b][1,4]dioxine, 2-(1-butyl)-2,3-dihydrothieno[3,4-b][1,4]dioxine, 2-(1-pentyl)-2,3-dihydrothieno[3,4-b][1,4]dioxine, 2-(1-hexyl)-2,3-dihydrothieno[3,4-b][1,4]dioxine, 2-(1-heptyl)-2,3-dihydrothieno[3,4-b][1,4]dioxine, 2-(1-octyl)-2,3-dihydrothieno[3,4-b][1,4]dioxine, 2,3-dihydrothieno[3,4-b][1,4]dioxine methanol, sodium 4-(2,3-dihydrothieno[3,4-b][1,4]dioxin-2-yl-methoxy)-1-propanesulfonate, sodium 4-(2,3-dihydrothieno[3,4-b][1,4]dioxin-2-yl-methoxy)-1-butanesulfonate and the like. Of these, 2,3-dihydrothieno[3,4-b][1,4]dioxine and 2-methyl-2,3-dihydrothieno[3,4-b][1,4]dioxine are preferable.

Examples of the other polymerizable monomer used in the invention include pyrrole represented by the following general formula (III):

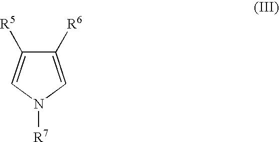

wherein R⁵ and R⁶, independently from each other, represent a monovalent group selected from the group consisting of a hydrogen atom, a linear or branched, saturated or unsaturated alkyl group having from 1 to 10 carbon atoms, a linear or branched, saturated or unsaturated alkoxy group having from 1 to 10 carbon atoms, a linear or branched, saturated or unsaturated alkyl ester group having from 1 to 10 carbon atoms, a halogen atom, a nitro group, a cyano group, a primary, secondary or tertiary amino group, a trihalomethyl group, a phenyl group and a phenyl group having a substituent, and R⁷ represents a monovalent group selected from the group consisting of a hydrogen atom, a linear or branched, saturated or unsaturated alkyl group having from 1 to 10 carbon atoms, a linear or branched, saturated or unsaturated alkoxy group having from 1 to 10 carbon atoms, a linear or branched, saturated or unsaturated alkyl ester group having from 1 to 10 carbon atoms, a halogen atom, a nitro group, a cyano group, a primary, secondary or tertiary amino group, a trihalomethyl group, a phenyl group and a phenyl group having a substituent, and derivatives thereof.

R⁵ and R⁶ may be bonded to each other in any position to form at least one 3- to 7-membered, saturated or unsaturated hydrocarbon cyclic structure. The cyclic structure may arbitrarily contain a carbonyl, ether, ester, amide, sulfide, sulfinyl, sulfonyl or imino bond, and the hydrocarbon forming the cyclic structure may have a group selected from the group consisting of a linear or branched, saturated or unsaturated alkyl, alkoxy or alkyl ester group having from 1 to 10 carbon atoms, a halogen atom, a nitro group, a cyano group, a primary, secondary or tertiary amino group, a trihalomethyl group, a phenyl group and a phenyl group having a substituent.

Specific examples of the monomer represented by the formula (III) can include pyrrole and derivatives thereof such as 3-methylpyrrole, 3-ethylpyrrole, 3-propylpyrrole, 3-butylpyrrole, 3-pentylpyrrole, 3-hexylpyrrole, 3-heptylpyrrole, 3-octylpyrrole, 3-nonylpyrrole, 3-decylpyrrole, 3-fluoropyrrole, 3-chloropyrrole, 3-bromopyrrole, 3-cyanopyrrole, 3,4-dimethylpyrrole, 3,4-diethylpyrrole, N-methylpyrrole, N-ethylpyrrole, 3,4-butylenepyrrole, 3,4-methylenedioxypyrrole and 3,4-ethylenedioxypyrrole.

The surfactant used in the invention may be a compound having a surface active effect that the polymerizable monomer can be emulsified in a solvent. Specific examples thereof include an anionic surfactant, a nonionic surfactant, a cationic surfactant, an ampholytic surfactant and the like.

Specific examples of the anionic surfactant include a fatty acid salt, an alkylsulfate, an alkylbenzenesulfonate, an alkylnaphthalanesulfonate, an alkylsulfosuccinate, an alkyl diphenyl ether disulfonate, an alkyl phosphate, a polyoxyethylene alkylsulfate, a polyoxyethylene alkylallyl sulfate, a naphthalenesulfonic acid formalin condensate, a special polycarboxylic acid-type polymeric surfactant, a polyoxyethylene alkyl phosphate and the like.

Specific examples of the nonionic surfactant include a polyoxyethylene alkyl ether, a polyoxyethylene alkylallyl ether, polyoxyethylene derivatives, an oxyethylene-oxypropylene block copolymer, a sorbitan fatty acid ester, a polyoxyethylenesorbitan fatty acid ester, a polyoxyethylene sorbitol fatty acid ester, a glycerin fatty acid ester, a polyoxyethylene fatty acid ester, a polyoxyethylene alkylamine, an alkyl alkanolamide and the like.

Specific examples of the cationic surfactant and the ampholytic surfactant include an alkylamine salt, a quaternary ammonium salt, an alkylbetaine, an amine oxide and the like.

Of the foregoing surfactants, the anionic surfactant is preferable. Especially, an anionic surfactant is preferable in which a part of a compound having a surface active effect is incorporated as a dopant of a conductive polymer formed by polymerization to contribute to improvement in conductivity. Preferable examples thereof include an alkylsulfate, an alkylbenzenesulfonate, an alkylnaphthalenesulfonate, an alkylanthraquinonesulfonate and the like. Specific examples thereof include p-toluenesulfonic acid, naphthalenesulfonic acid, anthraquinonesulfonic acid, and salts and derivatives thereof.

Further, in the invention, an external dopant other than the surfactant may be added, and a part thereof may be incorporated as a dopant of a conductive polymer formed by polymerization.

The oxidizing agent used in the invention may be an oxidizing agent capable of fully conducting a dehydrogenation 2-electron oxidative reaction, and a compound which is industrially less costly and easy to handle in production is preferable. Specific examples thereof include trivalent Fe compounds such as FeCl₃, FeClO₄ and Fe (organic acid anion) salt, anhydrous alminium chloride/cuprous chloride, alkali metal persulfates, ammonium persulfates, peroxides, manganese compounds such as potassium permanganate, quinones such as 2,3-dichloro-5,6-dicyano-1,4-benzoquinone (DDQ), tetrachloro-1,4-benzoquinone and tetracyano-1,4-benzoquinone, halogens such as iodine and bromine, peracids, sulfuric acid, fuming sulfuric acid, sulfur trioxide, sulfonic acids such as chlorosulfuric acid, fluorosulfuric acid and amide sulfuric acid, ozone and a combination of two or more thereof.

Of these, trivalent Fe compounds, cuprous chloride-based compounds, manganic acids and quinones are preferable, and trivalent Fe compounds are especially preferable.

As the solvent used in the invention, any solvent is available so long as the polymerizable monomer can be kept in an emulsified state with a surfactant. A solvent which dissolves or disperses the oxidizing agent is preferably used, and water is used especially preferably.

The initial concentration of the polymerizable monomer used in the invention at the start-up of the reaction has to be from 0.2 to 2.8 mol/L. It is preferably from 0.3 to 2.5 mol/L, most preferably from 0.4 to 2 mol/L. When the initial concentration of the polymerizable monomer is less than 0.2 mol/L, a diameter of micelles formed is small, and the monomer is eliminated and precipitated from micelles before satisfactory polymerization to form a polymer. Meanwhile, when it exceeds 2.8 mol/L, a stable emulsified state cannot be maintained which has an adverse effect on polymerization. It is thus undesirable.

The molar ratio of the surfactant used in the invention has to be from 0.8 to 1.6 mol per mol of the polymerizable monomer. It is preferably from 0.9 to 1.5 mol, most preferably from 1.0 to 1.4 mol. When it is less than 0.8 mol per mol of the polymerizable monomer, micelles are formed by emulsification, but conductivity of the resulting polymer is low. Thus, it is undesirable. Meanwhile, when it exceeds 1.6 mol, the polymerization reaction of the polymerizable monomer tends to be inhibited to decrease conductivity of the resulting polymer. It is thus undesirable.

The molar ratio of the oxidizing agent used in the invention is preferably from 0.05 to 1.5 mol, more preferably from 0.1 to 1.0 mol per mol of the polymerizable monomer. When the molar ratio of the oxidizing agent is less than 0.05 mol, the polymerization reaction proceeds very slowly, and a product might not be obtained in a satisfactory yield. When it exceeds 1.5 mol, an undesirable reaction might be induced in which a main-chain skeleton does not form a π-conjugated system to give a polymer having low conductivity.

The reaction temperature is not absolutely limited because it depends on the concentrations of the polymerizable monomer and the surfactant. However, the temperature is not particularly limited so long as the polymerization reaction proceeds. It is preferably from −10 to 60° C., more preferably from −5 to 40° C. At the polymerization temperature exceeding 60° C., an undesirable reaction is induced in which a main-chain skeleton does not form a π-conjugated system, and the conductivity of the resulting polymer is also low.

The conductivity of the conductive polymer obtained by the foregoing process is 80 S/cm or more, or even 130 S/cm or more under preferable conditions.

### EXAMPLES

The invention is described in detail below by referring to Examples. However, the invention is not limited by these Examples.

### Example 1

4 ml of distilled water was charged into a reaction vessel, and 0.44 g (2.1 mmol, equivalent to 0.35 mol/L) of sodium 2-naphthalenesulfonate (hereinafter abbreviated as 2NaNS) was added as a surfactant. Subsequently, 0.28 g (2.0 mmol, equivalent to 0.33 mol/L) of 2,3-dihydrothieno[3,4-b][1,4]dioxine (hereinafter abbreviated as HTDO) was added as a polymerizable monomer, and the mixture was stirred. A solution obtained by adding 0.28 g (0.7 mmol, equivalent to 0.12 mol/L) of iron (III) sulfate as an oxidizing agent to 2 ml of water was added dropwise to this solution over a period of one hour to start the reaction. The reaction was conducted with stirring at a temperature of 20° C. for 15 hours. The resulting black polymer was filtered, and the filtrate was washed with distilled water until pH reached 7. Then, the solution was washed twice with acetone, and vacuum-dried under a condition of a temperature of 40° C. for ten hours. The mass of the resulting polymer was 0.17 g. Subsequently, disc-like pellets having a diameter of 1.3 cm were produced from the polymer using a molding machine at a pressure of 3 t/cm² while reducing the pressure. Surface resistance of the pellets was measured using Loresta IP MCP-T250 (manufactured by Mitsubishi Chemical Corp.), and the resulting value of the surface resistance was multiplied by a film thickness for conversion to conductivity. The value is shown in Table 1.

### Example 2

The reaction was conducted under the same conditions as in Example 1 except that the amount of the surfactant was 0.55 g (2.6 mmol, equivalent to 0.44 mol/L). The mass of the resulting polymer was 0.17 g, and the result of measuring conductivity is shown in Table 1.

### Example 3

The reaction was conducted under the same conditions as in Example 1 except that the amount of the oxidizing agent was 0.20 g (0.5 mmol, equivalent to 0.086 mol/L). The mass of the resulting polymer was 0.16 g, and the result of measuring conductivity is shown in Table 1.

### Example 4

The reaction was conducted under the same conditions as in Example 1 except that the amount of the oxidizing agent was 0.40 g (1.0 mmol, equivalent to 0.17 mol/L). The mass of the resulting polymer was 0.19 g, and the result of measuring conductivity is shown in Table 1.

### Example 5

The reaction was conducted under the same conditions as in Example 1 except that the amount of the oxidizing agent was 0.56 g (1.4 mmol, equivalent to 0.24 mol/L). The mass of the resulting polymer was 0.19 g, and the result of measuring conductivity is shown in Table 1.

### Example 6

The reaction was conducted under the same conditions as in Example 1 except that 0.13 g (2.0 mmol, equivalent to 0.33 mol/L) of pyrrole (hereinafter abbreviated as PY) was used as the polymerizable monomer and the polymerization temperature was 5° C. The mass of the resulting polymer was 0.22 g, and the result of measuring conductivity is shown in Table 1.

### Comparative Example 1

8 ml of distilled water was charged into a reaction vessel, and 0.43 g (2.1 mmol, equivalent to 0.17 mol/L) of 2NaNS was added as a surfactant. Subsequently, 0.25 g (1.8 mmol/L, equivalent to 0.15 mol/L) of HTDO was added as a polymerizable monomer, and the mixture was stirred. A solution obtained by adding 0.26 g (0.65 mmol, equivalent to 0.055 mol/L) of iron (III) sulfate as an oxidizing agent to 4 ml of water was added dropwise to this solution over a period of one hour to start the reaction. The reaction was conducted with stirring at a temperature of 20° C. for 15 hours. Then, the same procedure as in Example 1 was conducted to obtain 0.16 g of a black polymer. The result of measuring conductivity of the resulting polymer is shown in Table 1.

### Comparative Example 2

The reaction was conducted under the same conditions as in Example 1 except that 2.6 g (18 mmol, equivalent to 3.1 mol/L) of HTDO was used as the polymerizable monomer, the surfactant was used in an amount of 4.1 g (20 mmol, equivalent to 3.3 mol/L) and the oxidizing agent was used in an amount of 2.6 g (6.5 mmol, equivalent to 1.1 mol/L). The mass of the resulting polymer was 0.20 g, and the result of measuring conductivity is shown in Table 1.

### Comparative Example 3

The reaction was conducted under the same conditions as in Example 1 except that the surfactant was used in an amount of 0.19 g (0.91 mmol, 0.15 mol/L). The mass of the resulting polymer was 0.12 g, and the result of measuring conductivity is shown in Table 1.

### Comparative Example 4

The reaction was conducted under the same conditions as in Example 1 except that the surfactant was used in an amount of 0.79 g (3.8 mmol, equivalent to 0.63 mol/L). The mass of the resulting polymer was 0.17 g, and the result of measuring conductivity is shown in Table 1.

TABLE 1

| | | Polymerizable | | | | | | |
|---|---|---|---|---|---|---|---|---|
| | | monomer | | Surfactant | | Oxidizing agent | | |
| | | | Concen- | Concen- | | Concen- | | Conduc- |
| | | | tration | tration | Molar | tration | Molar | tivity |
| | | Type | (mol/L) | (mol/L) | ratio | (mol/L) | ratio* | (S/cm) |
| Ex. | 1 | HTDO | 0.33 | 0.35 | 1.1 | 0.12 | 0.36 | 152 |
| | 2 | HTDO | 0.33 | 0.44 | 1.3 | 0.12 | 0.36 | 121 |
| | 3 | HTDO | 0.33 | 0.35 | 1.1 | 0.086 | 0.26 | 95 |
| | 4 | HTDO | 0.33 | 0.35 | 1.1 | 0.17 | 0.52 | 141 |
| | 5 | HTDO | 0.33 | 0.35 | 1.1 | 0.24 | 0.73 | 130 |
| | 6 | PY | 0.33 | 0.35 | 1.1 | 0.12 | 0.36 | 85 |
| Comp. | 1 | HTDO | 0.15 | 0.17 | 1.1 | 0.055 | 0.37 | 20 |
| Ex. | 2 | HTDO | 3.1 | 3.3 | 1.1 | 1.1 | 0.36 | 5 |
| | 3 | HTDO | 0.33 | 0.15 | 0.45 | 0.12 | 0.36 | 20 |
| | 4 | HTDO | 0.33 | 0.63 | 1.9 | 0.12 | 0.36 | 60 |

*Molar ratio: Ratio per mol of a polymerizable monomer

### INDUSTRIAL APPLICABILITY

Since the conductive polymer obtained by the process of the invention is excellent in conductivity, it is useful as electronics materials such as an electrode, a sensor, an electronics display device and a photoelectric transducer; various conductive materials such as an antistatic material; optical materials or various electronic parts.

1. A process for producing a conductive polymer, characterized by comprising conducting polymerization in the presence of a polymerizable monomer, a surfactant, a solvent and an oxidizing agent under initial conditions that a concentration of the polymerizable monomer is from 0.20 to 2.8 mol/L and a molar ratio of the surfactant is from 0.8 to 1.6 mol per mol of the polymerizable monomer.

2. The process for producing the conductive polymer according to claim 1, wherein the polymerizable monomer is represented by the general formula (I): 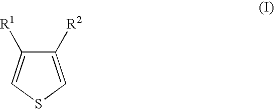
wherein R¹ and R², independently from each other, represent a monovalent group selected from the group consisting of a hydrogen atom, a linear or branched, saturated or unsaturated alkyl group having from 1 to 10 carbon atoms, a linear or branched, saturated or unsaturated alkoxy group having from 1 to 10 carbon atoms, a linear or branched, saturated or unsaturated alkyl ester group having from 1 to 10 carbon atoms, a halogen atom, a nitro group, a cyano group, a primary, secondary or tertiary amino group, a trihalomethyl group, a phenyl group and a phenyl group having a substituent.

3. The process for producing the conductive polymer according to claim 1, wherein the polymerizable monomer is represented by the general formula (II): 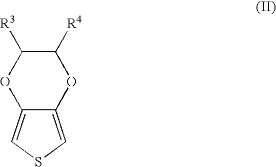
wherein R³ and R⁴, independently from each other, represent a monovalent group selected from the group consisting of a hydrogen atom, a linear or branched, saturated or unsaturated alkyl group having from 1 to 10 carbon atoms, a linear or branched, saturated or unsaturated alkoxy group having from 1 to 10 carbon atoms, a linear or branched, saturated or unsaturated alkyl ester group having from 1 to 10 carbon atoms, a halogen atom, a nitro group, a cyano group, a primary, secondary or tertiary amino group, a trihalomethyl group, a phenyl group and a phenyl group having a substituent.

4. The process for producing the conductive polymer according to claim 3, wherein the polymerizable monomer is 2,3-dihydrothieno[3,4-b][1,4]dioxine.

5. The process for producing the conductive polymer according to claim 1, wherein the polymerizable monomer is represented by the general formula (III): 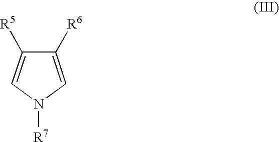
wherein R⁵, R⁶ and R⁷, independently from each other, represent a monovalent group selected from the group consisting of a hydrogen atom, a linear or branched, saturated or unsaturated alkyl group having from 1 to 10 carbon atoms, a linear or branched, saturated or unsaturated alkoxy group having from 1 to 10 carbon atoms, a linear or branched, saturated or unsaturated alkyl ester group having from 1 to 10 carbon atoms, a halogen atom, a nitro group, a cyano group, a primary, secondary or tertiary amino group, a trihalomethyl group, a phenyl group and a phenyl group having a substituent.

6. The process for producing the conductive polymer according to claim 5, wherein the polymerizable monomer is pyrrole.

7. The process for producing the conductive polymer according to claim 1, wherein the surfactant is an organic sulfonic acid compound.

8. The process for producing the conductive polymer according to claim 7, wherein the organic sulfonic acid compound is sodium naphthalenesulfonate or a derivative thereof.

9. The process for producing the conductive polymer according to claim 1, wherein the oxidizing agent is an iron salt.

10. The process for producing the conductive polymer according to claim 1, wherein the molar ratio of the surfactant is from 0.9 to 1.5 mol per mol of the polymerizable monomer.

11. The process for producing the conductive polymer according to claim 1, wherein the molar ratio of the oxidizing agent is from 0.05 to 1.5 mol per mol of the polymerizable monomer.

12. A conductive polymer obtained by the process according to claim 1.
